(19) United States
(12) Patent Application Publication
(10) Pub. No.: US 2009/0198691 A1
(43) Pub. Date: Aug. 6, 2009

(54) DEVICE AND METHOD FOR PROVIDING FAST PHRASE INPUT

(75) Inventors: Christian Kraft, Fredriksberg (DK); Peter Nielsen, Kgs Lyngby (DK)

Correspondence Address: PERMAN & GREEN, 425 POST ROAD, FAIRFIELD, CT, 06824, US

(73) Assignee: NOKIA CORPORATION, Espoo (FI)

(21) Appl. No.: 12/025,894

(22) Filed: Feb. 5, 2008

(51) Int. Cl. G06F 17/30; G06F 3/048

(52) U.S. Cl. 707/6; 715/780; 707/E17.014

(57) ABSTRACT

A user interface for receiving text in a device adapted to receive key input, the device having access to a dictionary database and including a controller arranged to match the key input against the dictionary database to find matching input candidates, wherein the key input corresponds to at least one character and the matching input candidate corresponds to a candidate phrase including at least one word and wherein each of the at least one character matches a first character of the at least one word of the candidate phrase and wherein the order of the at least one characters of the key input is the same as the order of the at least one words having a first character matching the at least one characters in the candidate phrase.

### FIELD

The present application relates to a device and a method for text input and in particular to a device and a method for text input of phrases.

### BACKGROUND

More and more electronic devices such as mobile phones, mobile web browsers, MP3 players, Personal Digital Assistants (PDAs) are becoming smaller and smaller while having more and more information stored and/or accessible through them. Users are relying on these devices and becoming all the more dependent on them.

The environments in which these devices are used are also becoming more and more hectic with higher demands on fast access and multitasking, and not only in a professional environment but also in private and social environments. For example a user should be able to read a book, while holding a grocery bag in a rattling subway train and still be able to use the device to live up to the many requirements posed upon it by a user buying and using the device.

Therefore it is important to have a quick and easy to use and learn way of entering text in a mobile device. Many mobile phones have tried to speed up the process of inputting text through a limited keypad such as an ITU-T keypad and predictive text input such as used by Tegic's T9©, Motorola's iTap© and Zi Corporation are very popular for disambiguating input received through an ITU-T keypad on which the characters of an alphabet are distributed over the keys so that each of the number keys correspond to more than one character as is commonly known. These predictive text input engines work so that a user inputs the keys corresponding to the characters to be input and the predictive engine searches a dictionary to find matching word candidates that are then proposed to and selected by a user. For example to input the word “Hello” a user would type in the sequence: 4 (‘H’), 3 (‘e’), 5 (‘l’), 5 (‘l’) and 6 (‘o’) whereupon the predictive engine would subsequently propose characters corresponding to the key combinations thereto input and eventually the wanted word “Hello” would be one or the only candidate for the user to select.

To input longer words the user still needs to press one key for every character and many devices have been implemented with word completion features in which among the word candidates proposed are also words that have the input key sequence as a prefix. For example, “Hello” could be shown as an alternative already after the first two keys have been pressed, 4 and 3 for “He”. This speeds up the input of longer words as the user is provided with the option of selecting the candidate already after only a first part of the word has been input.

However, for long words the user will have to input quite a few keys or characters before the word is sufficiently identified, especially with input of a whole sentence.

Text input is used for many applications running on mobile devices. It can be input of a message text body, a contact name, a web address, a search string and many other uses.

One method that tries to alleviate these problems and speed up text input for searching a database is presented in GB 2.308.473 that disclose a method for searching a computer database for titles of records that minimizes the number of key strokes to be made for entering characters of the title and comprises initially searching with a search string which comprises the letters of a first part of the title to be searched; e.g. to search for the title “MURPHYS SUPPORTS KNEE MEDIUM”, a search string comprising the first characters “MURPHYS S” is entered. A search is carried out and the first title in alphabetical order containing those characters is displayed, namely, “MURPHYS SUPPORTS FOOT LARGE” with the cursor 10 on the letter “S” of “SUPPORTS”. The cursor is transferred to the letter “F” of “FOOT” by operating the tab key and the letter “F” is changed to a “K” by entering the letter “K”. A further search is carried out using the search string “MURPHYS SUPPORTS K” which displays “MURPHYS SUPPORTS KNEE LARGE”. In similar fashion further searches are carried out to reveal the title “MURPHYS SUPPORTS KNEE MEDIUM”.

This method has the disadvantages that a search in the database is done repeatedly for each new character input (and for each word in the phrase) which takes time. In the example above 4 searches are made and the user has to control the cursor using the tab key to position it in the right position. This takes a lot of cognitive effort in that the user has to analyze the proposed text to identify the differences, and control the feature so that the right phrase is finally the end result. In the example above these actions need to be done three times, making it almost as difficult, from a cognitive effort perspective, to simply input the phrase directly. Secondly a user has to approve each following word, which also takes time and forces the user to move his fingers between a select key and the character keys repeatedly. Furthermore the display can become confusing as the user is required to input and to correct characters in the middle of the text. This requires cognitive effort to switch focus and make decisions and can be difficult to learn and is time consuming to use.

### SUMMARY

On this background, it would be advantageous to provide a device and a method that overcomes or at least reduces the drawbacks indicated above by providing a user interface for receiving text in a device adapted to receive key input, said device having access to a dictionary database and comprising a controller arranged to match said key input against said dictionary database to find matching input candidates, wherein said key input corresponds to at least one character and said matching input candidate corresponds to a candidate phrase comprising at least one word and wherein each of said at least one character matches a first character of said at least one word of said candidate phrase and wherein the order of the at least one characters of the key input is the same as the order of said at least one words having a first character matching said at least one characters in said candidate phrase.

By using the abbreviated form of a phrase it is easy for a user to remember them and know how to input or re-create them. It also makes it easy to combine such a phrase dictionary with existing predictive word input dictionaries thereby providing fast access times to the dictionary database.

Using such dictionaries prevents making exhaustive searching through databases which saves a lot of time, especially when the database is not stored locally or on a slower storage medium.

In one alternative or additional embodiment the user interface is arranged to receive in put of a first character and at least one consecutive character and wherein said user interface is further arranged to match said first character to a first character of a first word in a phrase stored in a dictionary database and to match each at least one consecutive character with a first character of a consecutive word in said phrase, wherein said words being matched have the same corresponding order within said phrase as the match at least one consecutive characters have with relation to each other.

In one embodiment the user interface further comprises a keypad arranged to provide said key input. This enables a user to quickly input text and phrases.

In one embodiment the keypad comprises physical keys and/or virtual keys. And inn one embodiment the key input is generated through hand writing recognition, HWR, input.

The physical keys can be arranged as QWERTY, AZERTY, ITU-T or S60 keypads.

In one embodiment the key input is ambiguous and said controller is arranged to match said key input for all combinations of said ambiguous key input. Using ambiguous input reduces the number of key presses required.

In one embodiment the user interface further comprises a display and wherein said controller is arranged to display said matching input candidates on said display. By displaying the candidates the user is made aware of the available options.

In one embodiment the controller is arranged to receive user input identifying a displayed matching candidate and to add said identified matching candidate to a text body.

In one embodiment the controller is further arranged to match said key input against a predictive text input dictionary to find further matching candidates and to display said further matching candidates and said matching characters adjacent each other. This provides for a fast input taking advantage of the predictive input for phrases already known t the system.

In one embodiment the controller is arranged to display said matching candidates in a list or said controller is arranged to display a first matching candidate as part of already input text.

In one embodiment the database is a local database. This enables a fast access and matching.

In one embodiment the database is a remote database. This enables a larger dictionary to be used.

In one embodiment the controller is arranged to receive said key input through a message text body. This provides for the possibility for the matching to be done at a later stage in a server or receiving device. It also makes it possible to use the feature in a device not equipped with it in that the user types in the abbreviated form and the message is sent as it is written. A later device, such as an interlaying server or recipient device equipped with the feature then performs the matching using the message body text as the key input whereupon the message text is parsed for abbreviated strings which are matched against a phrase dictionary.

In one embodiment the controller is arranged to add at least one of said matching candidates to a text body and send said text body in a message.

The aspects of the disclosed embodiments are also directed to providing a method for matching a key input against a database, said key input comprising at least one character and said database comprising at least one candidate phrase comprising at least one word, said method comprising comparing each of said at least one character of said key input against a first character of a word of said candidate phrase wherein the order of the at least one characters of the key input is the same as the order of said at least one words having a first character matching said at least one characters in said candidate phrase.

In one embodiment the method further comprises accessing said database remotely or locally.

In one embodiment the method further comprises receiving said key input through a keypad.

In one embodiment the method further comprises receiving said key input through a message.

In one embodiment the method further comprises displaying said matching candidates on a display.

In one embodiment the method further comprises receiving user input identifying a matching candidate providing an identified phrase.

In one embodiment the method further comprises adding said identified phrase to a text body.

The aspects of the disclosed embodiments are also directed to providing a device arranged to perform a method according to above.

The aspects of the disclosed embodiments are also directed to providing a computer readable medium including at least computer program code for controlling a user interface comprising a database and a received key input comprising at least one character and said database comprising at least one candidate phrase comprising at least one word, said computer readable medium comprising software code for comparing each of said at least one character of said key input against a first character of a word of said candidate phrase wherein the order of the at least one characters of the key input is the same as the order of said at least one words having a first character matching said at least one characters in said candidate phrase.

In one embodiment the computer readable medium as above further comprises software code for receiving user input identifying a matching candidate providing an identified phrase.

In one embodiment the computer readable medium as above further comprises software code for adding said identified phrase to a text body.

In one embodiment the computer readable medium as above further comprises software code for accessing said database remotely or locally.

In one embodiment the computer readable medium as above further comprises software code for receiving said key input through a keypad.

In one embodiment the computer readable medium as above further comprises software code for receiving said key input through a message.

In one embodiment the computer readable medium as above further comprises software code for displaying said matching candidates on a display.

The aspects of the disclosed embodiments are also directed to providing a device incorporating and implementing a computer readable medium according to above.

The aspects of the disclosed embodiments are also directed to providing a device comprising a user interface such as described above.

In one embodiment the device is a mobile terminal.

In one embodiment the device is a mobile communications terminal.

In one embodiment the device is a mobile web browser.

In one embodiment the device is a mobile email client.

In one embodiment the device is a mobile phone.

In one embodiment the device is a server.

The aspects of the disclosed embodiments are also directed to providing a system comprising a device as in above and a server as above.

In one embodiment the server is arranged to perform said matching.

In one embodiment the device is arranged to perform said matching.

The aspects of the disclosed embodiments are also directed to providing a device for receiving text comprising means for receiving key input, means for accessing a dictionary database and means for matching said key input against said dictionary database for finding matching input candidates, wherein said key input corresponds to at least one character and said matching input candidate corresponds to a candidate phrase comprising at least one word and wherein each of said at least one character matches a first character of said at least one word of said candidate phrase and wherein the order of the at least one characters of the key input is the same as the order of said at least one words having a first character matching said at least one characters in said candidate phrase.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a telecommunications system in which a device according to the present application is used according to an embodiment,

FIG. 2 is a plane front view of a device according to an embodiment,

FIG. 3 is a block diagram illustrating the general architecture of a device of FIG. 1 in accordance with the present application,

FIG. 4a, b, c and d are display views of a device according to an embodiment,

FIG. 5 is a flow chart describing a method according to an embodiment,

FIG. 6 is a schematic view of a data structure according to an embodiment.

### DETAILED DESCRIPTION

In the following detailed description, the device, the method and the software product according to the teachings for this application in the form of a cellular/mobile phone will be described by the embodiments. It should be noted that although only a mobile phone is described the teachings of this application can also be used in any electronic device such as in portable electronic devices such as laptops, PDAs, mobile communication terminals, electronic books and notepads and other electronic devices offering access to information.

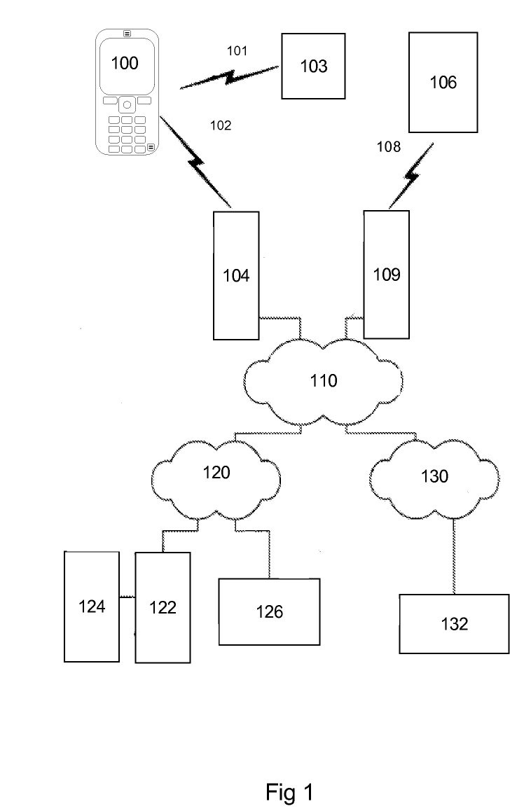

FIG. 1 illustrates an example of a cellular telecommunications system in which the teachings of the present application may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the teachings of the present application and other devices, such as another mobile terminal 106 or a stationary telephone 132. It is to be noted that for different embodiments of the mobile terminal 100 and in different situations, different ones of the telecommunications services referred to above may or may not be available; the teachings of the present application are not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, etc. The local devices 103 can for example be various sensors that can communicate measurement values to the mobile terminal 100 over the local link 101.

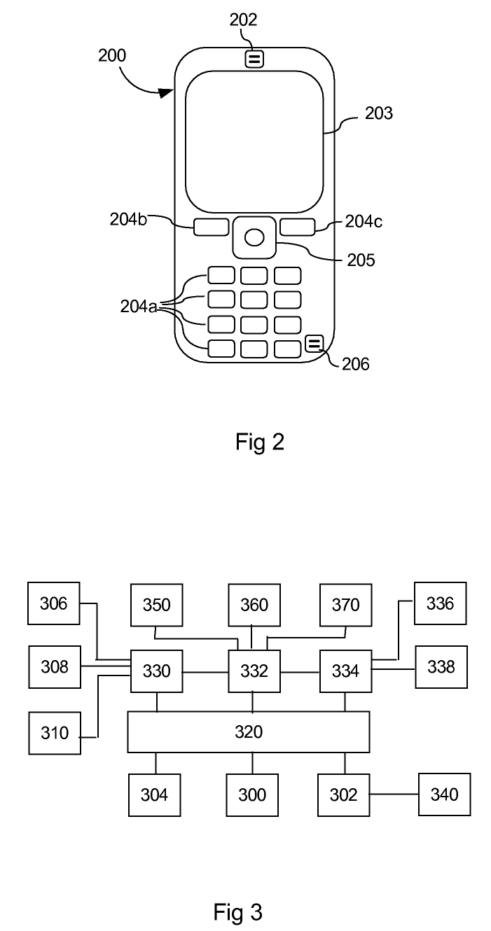

An embodiment 200 of the mobile terminal 100 is illustrated in more detail in FIG. 2. The mobile terminal 200 comprises a speaker or earphone 202, a microphone 206, a main or first display 203 and a set of keys 204 which may include a keypad 204a of common ITU-T type (alpha-numerical keypad representing characters “0”-“9”, “*” and “#”) and certain other keys such as soft keys 204b, 204c and a joystick 205 or other type of navigational input device. The keys of the keypad 204a are also assigned characters according to table 1.

TABLE 1
Keys of a keypad and assigned characters

| | |
|---|---|
| Key | Assigned character |

| | |
|---|---|
| 1 | Punctuation marks |
| 2 | ‘a’, ‘b’ and ‘c’ |
| 3 | ‘d’, ‘e’ and ‘f’ |
| 4 | ‘g’, ‘h’ and ‘i’ |
| 5 | ‘j’, ‘k’ and ‘l’ |
| 6 | ‘m’, ‘n’ and ‘o’ |
| 7 | ‘p’, ‘q’, ‘r’ and ‘s’ |
| 8 | ‘t’, ‘u’ and ‘v’ |
| 9 | ‘w’, ‘x’, ‘y’ and ‘z’ |
| 0 | Space, ‘0’ or control |
| * | Control |
| # | Control |

It should be noted that other keypads such as a QWERTY, or AZERTY keypad could also be used.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data used by and program instructions for various software in the mobile terminal such as a dictionary data base 340. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, etc. It should be noted that two or more of the applications listed above may be executed as the same application

The MMI 334 also includes one or more hardware controllers, which together with the MMI drivers cooperate with the first display 336/203, and the keypad 338/204 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass fitters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

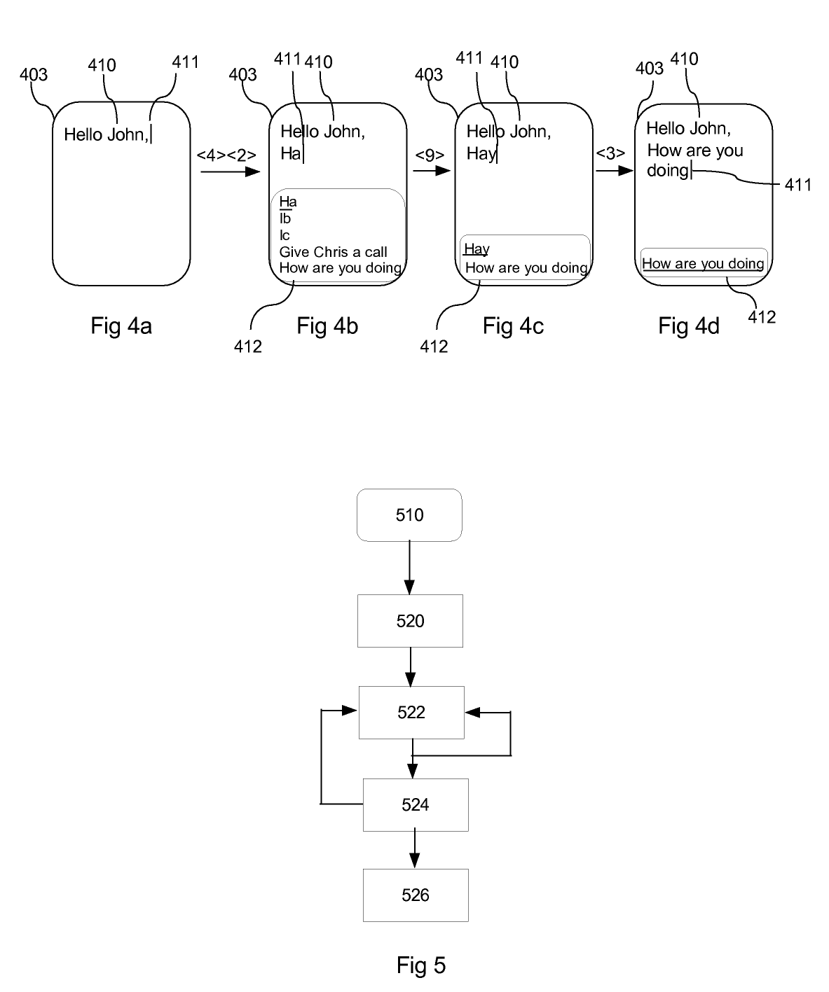

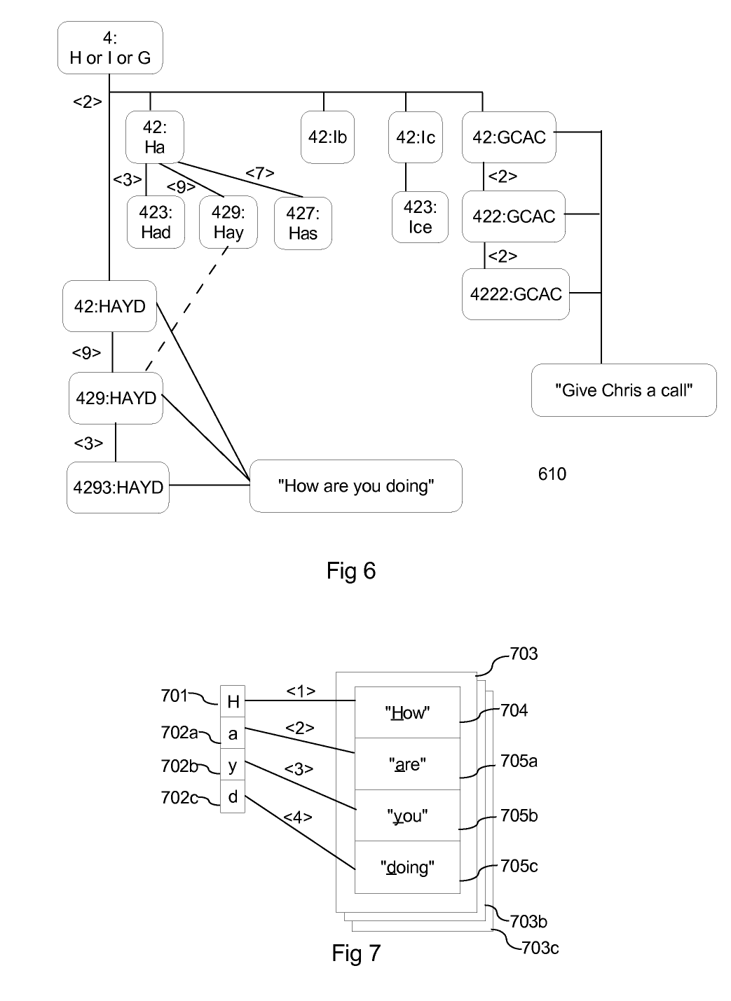

In the below simultaneous reference will be made to FIGS. 4 and 5. FIG. 4 show a series of display views or screen shots of a display 403 in a device as described with reference to FIG. 2. FIG. 5 show a flowchart of a method according to this application. In FIG. 4a a text body 410 “Hello John,” has already been input and is displayed on the display 403. A cursor 411 is displayed after the text body 410 to indicate where the following text should be input. This is indicated as the initial step 510 in FIG. 5. As a user inputs the keys 4 and 2 (see arrow marked <4><2>) in step 520 each of the possible characters assigned to the key (204a shown in FIG. 2) being pressed is matched against a dictionary database 340 (shown in FIG. 3) stored in a memory 332 (shown in FIG. 3) of the device 200 (shown in FIG. 2). See below with reference to FIG. 6 for a description of how the searching and the dictionary database can be implemented.

If unambiguous input is used such as multi-tapping or via a QWERTY-keypad only one character candidate exists for each (multiple) key press.

The matching is performed so that each character is matched against a first character of a word belonging to a phrase stored in said database dictionary 340 in step 522 which is repeated until a matching candidate is found, until all matching candidates are found or until no further characters remain in the key input to be compared against the database dictionary 340.

Alternatively or additionally each database entry has a search key consisting of the first characters of each word in the phrase whereupon the searching can be made as is commonly known for predictive text input systems. Also see the description below with reference to FIG. 6.

If a match is found a list box 412 is displayed in step 524, see FIG. 4b, showing the matching candidates found for the key input. In this embodiment the candidates show both one-word candidates such as “Ha”, “Ib” and “Ic” as well as two candidate phrases “How are you doing” and “Give Chris a call”. The first matching candidate is also displayed adjacent to the cursor 411, in this case “Ha” which, in this embodiment, is also marked in the list box 412 by being underlined as the default candidate which will be chosen upon selection. It should be noted that other ways of marking such as highlighting etc is also possible. A user can scroll through the matching candidates using the navigation key 205 (shown in FIG. 2) changing which candidate is shown by the cursor 411 and then choose a different candidate. Selection can be executed via a select button or by inputting a control character such as a punctuation mark or a space. It should be noted that the further key input and matching thereof is irrespective of which candidate is underlined. Only upon selection is the end result provided and the matching restarted.

Alternatively and/or additionally the matching candidates are only shown one at a time at the place of the cursor.

As a user continues to provide key input by pressing the keys 204a further matching is made and a new candidate list is shown in the candidate list box 412. See FIG. 4C. As indicated by the arrow marked <9> the key 9 have been pressed and the candidate phrase “Give me a call” no longer matches the key input “429” corresponding to “hayd”. Only the candidates “Hay” and “How are you doing” are shown in the candidate box 412, “Hay” now being underlined. A further key press <3> results in that the only candidate left is “How are you doing” and it is shown both in the list box 412 and by the cursor 411. Alternatively it could only be shown by the cursor to indicate that there are no further choices as there is no list box 412 shown.

It should be noted that the steps 522 and 524 can be made simultaneously or one after another. Using a data structure such as described herein or with reference to FIG. 6 would imply a simultaneous execution of steps 522 and 524 as well as a simultaneous search and receipt of key input. Although, it could also be made asynchronously.

The cursor is always positioned where the next character is supposed to be input and if a user knows his phrases he need only input the abbreviated form of the phrase for the matching to find the wanted phrase quickly.

As a user selects a candidate it is shown by the cursor 411 irrespective of its position in the list box 412, the list box is removed and the cursor is placed at the end of the candidate phrase in step 526 and the situation is as in FIG. 4a but with the text body 410 now stating “Hello John, How are you doing”.

As can be seen from FIGS. 4 and 5 the teachings herein provide for input of phrases that require little cognitive effort in that proposed candidates are represented in their final version and no change is required inside the phrase. As only one search is made for the matching phrase the feature is very fast to use. This provides a fast and easy to use and learn way of inputting phrases.

In an alternative embodiment a device receives the key input from a text body, perhaps stemming from a message received or generated in start step of 510. As the message text is parsed key input sequences are generated in step 520 and matched against a dictionary data base 340 in step 522. Possibly the resulting candidates are displayed on a display 524 for user selection or they are selected automatically by the controller 300. The selected candidates are added to a text body in step 526.

FIG. 6 show a tree structure used for matching the key input against the dictionary database 340. In FIG. 6 only the nodes used are shown as the view would otherwise be too cluttered. FIG. 6 show the dictionary database being used for both phrase recognition as well as predictive word input simultaneously. In this embodiment the database is a dictionary data structure preferably implemented as a tree structure.

In a starting step 510 the keys <4> and <2> have been received and the nodes corresponding to this sequence are shown as 42:Ha, 42:Ib, 42:Ic, 42:HAYD and 42:GCAC. These nodes have been found in a matching step 522 through a node labeled 4:H or I or G which in fact would be implemented as three nodes, but are shown here as one for illustrative purposes. Some of these nodes have further alternatives, sub-nodes, corresponding to further input. In FIG. 6 these are the nodes 42:Ha, 42:Ic, 42:HAYD and 42:GCAC. As can be seen the nodes 42:GCAC and 42:HAYD are associated with a candidate phrase 610. These nodes being associated with a candidate phrase 610 can either be stand alone nodes such as 42:GACC or as sub-nodes of another node. A dashed line indicates where the node 429:HAYD would be placed under 429:Hay if it was a sub node. One noticeable difference in whether they are standalone nodes or sub-nodes is how many key presses it takes to find them in the matching step. A standalone node is found much quicker. Although having too many standalone nodes would cause too many candidates to e shown which would make it difficult for a user to find the wanted candidate. The latter example of a sub-node makes it quicker to search as it gives fewer matches for each character where as the former is easier to implement as the nodes can be part of different databases.

As further key input is received <9> and matched 522 fewer nodes become possible and only 429:Hay and 429:HAYD are possible. Should the user wish so, selection of this node HAYD is possible at any time. Or the user could input further key input <3> 522 again the node 4293:HAYD being the only alternative. For each key input the resulting candidates are displayed 524.

Instead of a node being directly associated with a text node 610 a second lookup could be used wherein the node's text HAYD is matched against a dictionary database containing only the corresponding phrases.

Examples of such dictionary structures are used by Tegic's T9©, by Motorola's iTap© and by Zi-Corporation and can thus easily be modified to be used with the teachings herein.

Using such dictionaries prevents making exhaustive searching through databases which saves a lot of time, especially when the database is not stored locally or on a slower storage medium.

One example of use is shown below where a user subsequently presses keys and the corresponding phrases are shown.
4_{ghi}: “I”
5ⱼₖₗ:“Hl”
9_{wxyz}: “I love you”
7_{pqrs}: “I love you so”
6ₘₙₒ: “I love you so much”

Note that as each key input is received a further candidate phrase is found and displayed (steps 522 and 524).

In one embodiment the matching is done by a server such as a base station 104 when receiving a message sent from one device 100 to be sent to a second device 106 using the characters in the text body as a key input sequence.

In one embodiment the matching is done by a receiving device 106 after having received a message using the characters in the text body as a key input sequence.

It should be noted that by a combination of the above compression of a message is possible in which the phrases are substituted by their first character abbreviations and sent to a second device where the abbreviations are expanded. This can be done with or without user interaction depending on the available bandwidth, the need for secrecy and other usage parameters.

If a user wants to write “How are you doing” or rather that the user intends for the recipient to read this phrase, the user can simply write the abbreviation “Hayd” and send the message. As the message is received in the recipient's device it can either be automatically parsed or a user can command it explicitly, either for the whole text or for chosen strings. The matched phases are shown to a user for selection, or depending on user settings the text is updated automatically with the candidates. If the device is set to parse incoming messages automatically a user could be prompted for any string not making any sense if he wants to replace it with a matching phrase.

In this way a user receiving a message reading “Hi John, hayd? Lftn Monday. Gmrt L.” Could have it rephrased to read “Hi John, How are you doing? Looking forward to next Monday! Give my regards to Linda.” making more sense.

A preferred embodiment is when the database dictionary 340 is located in the same device or locality as the controller 300 so that the matching can be done quickly and effortlessly.

Database dictionaries 340 can either be preloaded into a device or be created by a user or downloaded from a server.

FIG. 7 show an alternative or additional embodiment. This embodiment can also be perceived as a re-phrasing of certain aspects of the embodiments described above. A string of characters are being input consisting of a first character 701 followed by three consecutive characters 702a, b and c. Each character of the string are being matched by a controller (not shown here, but referred to as 340 in FIG. 3) against phrases 703 stored in a dictionary database (not shown). Each phrase 703 comprises at least two words, a first word 704 and at least one consecutive word, in this example 3 consecutive words 705a, b and c. In a first step <1> the first character 701 is matched against the first character of the first word 704 of the phrase 703. The first character of each word is shown being underlined in FIG. 7. If the first character 701 matches the first character of the first word 705 in step <1> the controller optionally displays the phrase as a candidate for user selection. The controller proceeds with matching the consecutive character 703a with the first character of a consecutive word 705a in step <2>. If these also match the controller continues with the other consecutive characters in their order 703b and 703c and match them against the first characters of the consecutive words 705b and 705c respectively. This is done step by step (steps <3> and <4> in FIG. 7) until either both the string and the phrase has no more consecutive characters or words respectively, a user accepts the candidate(s) shown or a mismatch occurs. A mismatch occurs when a character 701 or 702 in the sting does not match its corresponding first character of a word 704, 705 or when a character 701 or 702 does not have a corresponding word to be matched against.

It should be noted that this matching can be done simultaneously against more than one phrase as indicated in FIG. 7 by phrases 703b and 703c. If more than one phrase has matching words these phrases are also displayed until either a selection is made or a mismatch occurs.

It should also be noted that the matching can be done simultaneous with predictive text input using a predictive text input engine such as Tegic's T9™, Motorola's iTap™ or any engine from Zi corporation.

In one embodiment the controller keeps track of previously input word combinations, ie phrases and stores them in the phrase dictionary. Which phrases that are stored could be determined on criteria such as number of times used, frequency of usage, number of times in the last 10 days (or any other time period), frequency of usage in the last 10 days (or any other time period). Alternatively or additionally the user could be made aware as a new phrase is being added to the database phrase dictionary.

The various aspects of what is described above can be used alone or in various combinations. The teaching of this application may be implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), game consoles, MP3 players, personal organizers, video and photography cameras or any other device designed for receiving and/or displaying text.

The teaching of the present application has numerous advantages. Different embodiments or implementations may yield one or more of the following advantages. It should be noted that this is not an exhaustive list and there may be other advantages which are not described herein. One advantage of the teaching of this application is that text input of commonly used phrases wilt be much faster and if the phrases are stored in relation to the normally used predictive text input dictionary no time consuming dictionary database look-up is needed.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as music players, palmtop computers and the like. It should also be noted that there are many alternative ways of implementing the methods and apparatuses of the teachings of the present application. [

The term “comprising” as used in the claims does not exclude other elements or steps. The term “a” or “an” as used in the claims does not exclude a plurality. A unit or other means may fulfill the functions of several units or means recited in the claims.

1. A user interface for receiving text in a device adapted to receive key input, said device having access to a dictionary database and comprising a controller arranged to match said key input against said dictionary database to find matching input candidates, wherein said key input corresponds to at least one character and said matching input candidate corresponds to a candidate phrase comprising at least one word and wherein each of said at least one character matches a first character of said at least one word of said candidate phrase and wherein the order of the at least one characters of the key input is the same as the order of said at least one words having a first character matching said at least one characters in said candidate phrase.

2. A user interface according to claim 1 further comprising a keypad arranged to provide said key input.

3. A user interface according to claim 2, wherein said keypad comprises physical keys and/or virtual keys.

4. A user interface according to claim 1, wherein said key input is ambiguous and said controller is arranged to match said key input for all combinations of said ambiguous key input.

5. A user interface according to claim 1, further comprising a display and wherein said controller is arranged to display said matching input candidates on said display.

6. A user interface according to claim 5, wherein said controller is arranged to receive user input identifying a displayed matching candidate and to add said identified matching candidate to a text body.

7. A user interface according to claim 5, wherein said controller is further arranged to match said key input against a predictive text input dictionary to find further matching candidates and to display said further matching candidates and said matching characters adjacent to each other.

8. A user interface according to claim 5, wherein said controller is arranged to display said matching candidates in a list or said controller is arranged to display a first matching candidate as part of already input text.

9. A user interface according to claim 1, wherein said database is a local database.

10. A user interface according to claim 1, wherein said database is a remote database.

11. A user interface according to claim 1, wherein said controller is arranged to receive said key input through a message text body.

12. A user interface according to claim 1, wherein said controller is arranged to add at least one of said matching candidates to a text body and send said text body in a message.

13. A method for matching a key input against a database, said key input comprising at least one character and said database comprising at least one candidate phrase comprising at least one word, said method comprising comparing each of said at least one character of said key input against a first character of a word of said candidate phrase wherein the order of the at least one characters of the key input is the same as the order of said at least one words having a first character matching said at least one characters in said candidate phrase.

14. A method according to claim 13, further comprising accessing said database remotely or locally.

15. A method according to claim 13, further comprising receiving said key input through a keypad.

16. A method according to claim 13, further comprising receiving said key input through a message.

17. A method according to claim 13, further comprising displaying said matching candidates on a display.

18. A method according to claim 13, further comprising receiving user input identifying a matching candidate providing an identified phrase.

19. A method according to claim 18, further comprising adding said identified phrase to a text body.

20. A device arranged to perform a method according to claim 13.

21. A computer readable medium including at least computer program code for controlling a user interface comprising a database and a received key input comprising at least one character and said database comprising at least one candidate phrase comprising at least one word, said computer readable medium comprising software code for comparing each of said at least one character of said key input against a first character of a word of said candidate phrase wherein the order of the at least one characters of the key input is the same as the order of said at least one words having a first character matching said at least one characters in said candidate phrase.

22. A computer readable medium as in claim 21 further comprising software code for receiving user input identifying a matching candidate providing an identified phrase.

23. A computer readable medium as in claim 21 further comprising software code for adding said identified phrase to a text body.

24. A computer readable medium as in claim 21 further comprising software code for accessing said database remotely or locally.

25. A computer readable medium as in claim 21 further comprising software code for receiving said key input through a keypad.

26. A computer readable medium as in claim 21 further comprising software code for receiving said key input through a message.

27. A computer readable medium as in claim 21 further comprising software code for displaying said matching candidates on a display.

28. A device incorporating and implementing a computer readable medium according to claim 21.

29. A device comprising a user interface such as in claim 1.

30. A device such as in claim 20, wherein said device is a mobile terminal.

31. A device such as in claim 30, wherein said device is a mobile communications terminal.

32. A device such as in claim 31, wherein said device is a mobile web browser.

33. A device such as in claim 31, wherein said device is a mobile email client.

34. A device such as in claim 31, wherein said device is a mobile phone.

35. A device such as in claim 20, wherein said device is a server.

36. A system comprising a device as in claim 30 where the device is a server.

37. A system as in claim 36 where said server is arranged to perform said matching.

38. A system as in claim 36 where said device is arranged to perform said matching.

39. A device for receiving text comprising means for receiving key input, means for accessing a dictionary database and means for matching said key input against said dictionary database for finding matching input candidates, wherein said key input corresponds to at least one character and said matching input candidate corresponds to a candidate phrase comprising at least one word and wherein each of said at least one character matches a first character of said at least one word of said candidate phrase and wherein the order of the at least one characters of the key input is the same as the order of said at least one words having a first character matching said at least one characters in said candidate phrase.
